(19) United States
(12) Patent Application Publication
(10) Pub. No.: US 2017/0043829 A1
(43) Pub. Date: Feb. 16, 2017

(54) BICYCLE AND PARKING CONTROL DEVICE THEREOF

(71) Applicants: LE HOLDINGS (BEIJING) CO., LTD., Beijing (CN); LETV SPORTS CULTURE DEVELOP (BEIJING) CO., LTD., Beijing (CN)

(72) Inventor: Dalong LI, Beijing (CN)

(21) Appl. No.: 15/221,859

(22) Filed: Jul. 28, 2016

Related U.S. Application Data
(63) Continuation of application No. PCT/CN2016/082059, filed on May 13, 2016.

(30) Foreign Application Priority Data
Aug. 11, 2015 (CN) 201510491506.1

(51) Int. Cl. B62H 5/18; E05B 47/00; G01C 9/06; E05B 81/56; E05B 81/64; B62L 3/06; B62H 5/14; E05B 71/00

(52) U.S. Cl. CPC B62H 5/18; B62H 5/141; E05B 47/0012; E05B 71/00; E05B 81/56; E05B 81/64; B62L 3/06; G01C 9/06; E05B 2047/0072; E05B 2047/0067; E05B 2047/0094

(57) ABSTRACT

Disclosed are a bicycle and a parking control device including a lock, a parking switch button, a posture detection module, an unlocking module, and a control module. The parking switch button is installed on a control module, and configured to generate a trigger signal upon being pressed down; the control module is connected with the parking switch button, the posture detection module, the unlocking module, and the lock; and when the bicycle is unlocked, and the parking switch button is pressed down to generate trigger signal, the control module determines from posture information of the bicycle whether the bicycle satisfies a parking condition, if so, the control module will control the lock to lock the bicycle; when the bicycle is locked, the parking switch button is pressed down to generate trigger signal, the unlocking module generates a unlocking instruction, the control module controls the lock to unlock the bicycle.

### CROSS-REFERENCE TO RELATED APPLICATIONS

This application is continuation of International Application No. PCT/CN2016/082059, filed on May 13, 2016, which claims priority to Chinese Patent Application No. 201510491506.1, filed on Aug. 11, 2015, both of which are hereby incorporated by reference in their entireties.

### TECHNICAL FIELD

The present disclosure relates to the field of bicycles, and particularly to a bicycle, and a parking control device thereof.

### BACKGROUND

As people are accepting low carbon, environment conserving, healthy life, and other ideas, it has become popular to travel by riding a bicycle, and while a rider is traveling by riding a bicycle, the bicycle may be traveling or being parked, where if the bicycle is being parked, then the bicycle will be locked using a lock to thereby park the bicycle.

However in the prior art, if the bicycle is being parked, or being released from being parked, then the rider will operate manually on the lock directly to thereby lock the bicycle or unlock the bicycle so as to switch the bicycle between traveling and being parked, thus making the operation troublesome.

### SUMMARY

Embodiments of the disclosure provide a bicycle, and a parking control device thereof so as to address such a drawback in the prior art that the user has to operate manually on the lock so as to switch the bicycle between traveling and being parked, thus simplifying the operation of switching the bicycle between traveling and being parked.

Some embodiments of the disclosure provides a parking control device for a bicycle, the device includes a lock, a parking switch button, a posture detection module, an unlocking module, and a control module, wherein:
the parking switch button is installed on the control module, and configured to generate a trigger signal upon being pressed down;
the control module is connected by signals with the parking switch button, the posture detection module, the unlocking module, and the lock; and
when the bicycle is not locked, and the parking switch button is pressed down to generate the trigger signal, the control module determines from posture information of the bicycle detected by the posture detection module whether the bicycle satisfies a parking condition, and if so, then the control module will control the lock to lock the bicycle; and
when the bicycle is locked, the parking switch button is pressed down to generate the trigger signal, and the unlocking module generates a correct unlocking instruction, the control module controls the lock to unlock the bicycle.

Some embodiments of the disclosure provides a bicycle including a body, and the parking control device according to the technical solution above.

With the bicycle, and a parking control device according the embodiments of the disclosure, the lock is automatically controlled by cooperation of the parking switch button, the posture detection module, the unlock module and the control module so that a rider of the bicycle may control the lock to lock the bicycle only by operation for the parking switch button, while unlocking the lock by operation for the parking switch button and the unlock module, thereby addressing such a drawback in the prior art that the user has to operate manually on the lock so as to switch the bicycle between traveling and being parked, thus simplifying the operation of switching the bicycle between traveling and being parked.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic structural diagram in principle of a parking control device for a bicycle according to some embodiments of the disclosure;

FIG. 2 is a schematic structural diagram of an explosive view of a parking switch button, and a control module in a bicycle, cooperating with the body of the bicycle according to some embodiments of the disclosure; and

FIG. 3 is a schematic structural diagram of a bicycle according to some embodiments of the disclosure.

### DETAILED DESCRIPTION

In order to make the objects, technical solutions, and advantages of the embodiments of the disclosure more apparent, the technical solutions according to the embodiments of the disclosure will be described below clearly and fully with reference to the drawings in the embodiments of the disclosure, and apparently the embodiments described below are only a part but not all of the embodiments of the disclosure. Based upon the embodiments here of the disclosure, all the other embodiments which can occur to those skilled in the art without any inventive effort shall fall into the scope of the disclosure.

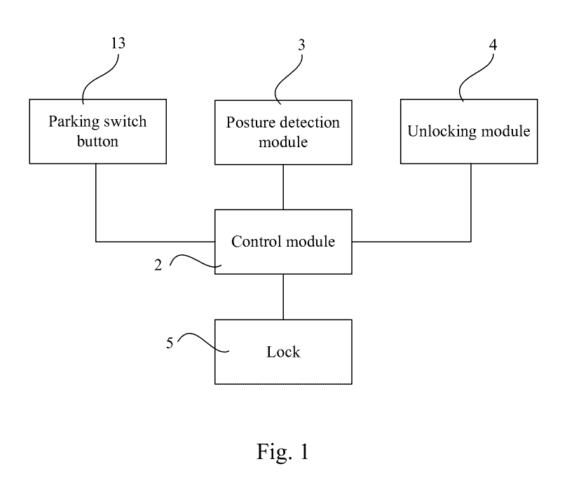

As illustrated in FIG. 1, a parking control device for a bicycle according to some embodiments of the disclosure includes a lock 5, a parking switch button 13, a posture detection module 3, an unlocking module 4, and a control module 2, where:

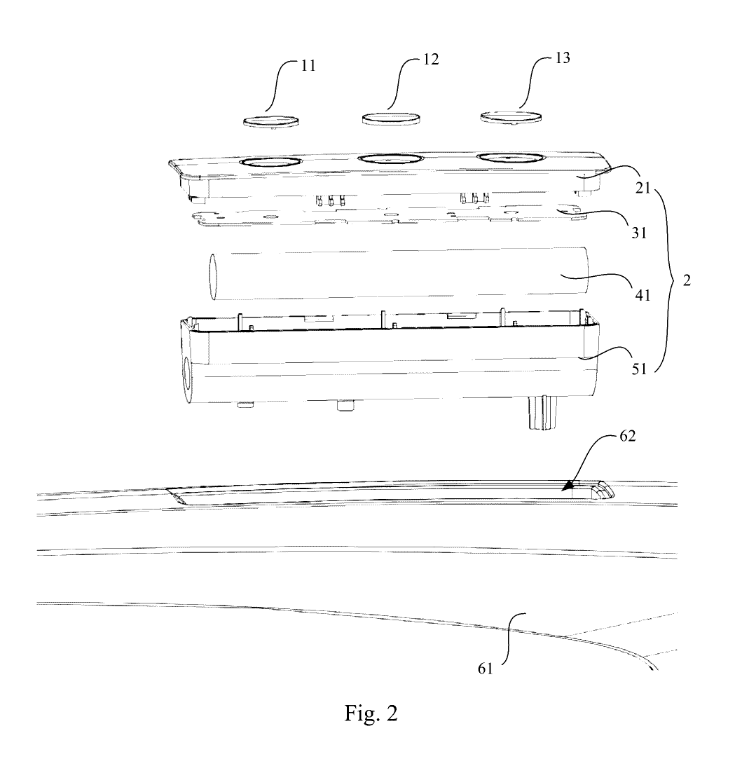

As illustrated in FIG. 2, the parking switch button 13 is installed on a control module, and configured to generate a trigger signal upon being pressed down;

The control module 2 is connected by signals with the parking switch button 13, the posture detection module 3, the unlocking module 4, and the lock 5; and

When the bicycle is not locked, and the parking switch button 13 is pressed down to generate the trigger signal, the control module 2 determines from posture information of the bicycle detected by the posture detection module 3 whether the bicycle satisfies a parking condition, and if so, then the control module 2 will control the lock 5 to lock the bicycle; and

When the bicycle is locked, the parking switch button 13 is pressed down to generate the trigger signal, and the unlocking module 4 generates a correct unlocking instruction, then the control module 2 will control the lock 5 to unlock the bicycle.

In the parking control device for a bicycle, when the bicycle needs to be parked, its rider only need to press down the parking switch button 13 simply, and at this time, the control module 2 determines from the information detected by the posture detection module 3 whether the bicycle satisfies such a parking condition that the bicycle is parked, that is, the velocity of the bicycle is zero; and when the bicycle is parked, then the control module 2 may determine that the bicycle satisfies the parking condition at this time, and then control the lock 5 to lock the bicycle so that the bicycle is switched from traveling to being parked. When the bicycle needs to be released from being locked by the lock, the rider presses down the parking switch button 13, and at this time, the bicycle is parked, and the control module 2 starts the unlocking module 4 upon reception of the trigger signal generated by the parking switch button 13 being pressed down; and the rider inputs an unlocking signal through the unlocking module 4, and when the unlocking signal generated by the unlocking module 4 is correct, the control module 2 controls the lock 5 to unlock the bicycle, so that the bicycle is switched from being parked to traveling.

Thus the aforementioned parking control device for a bicycle can address such a drawback in the prior art that the rider has to operate manually on the lock directly to thereby switch the bicycle between traveling and being parked, thus simplifying the operation of switching the bicycle between traveling and being parked.

Particularly the lock 5 is an electronic lock.

When the lock 5 is an electronic lock, the lock 5 includes:

A slider configured to protrude into a hole of a brake piece of the bicycle while the bicycle is being parking; and

A drive electro motor connected with the control module 2 and configured to operationally drive the slider into operation.

The lock 5 structured above is simplified in structure, and can lock the bicycle stability when the slider protrudes into the hole of the brake piece on the bicycle.

Particularly in the parking control device above, the posture detection module 3 can include one of or both a Hall sensor and a gyroscope to thereby improving the precision of detecting by the posture detection module 3 the velocity of the bicycle.

Of course, in the parking control device above, the unlocking module 4 can perform its unlocking function in a number of ways.

For example, the unlocking module 4 can include at least one of a keypad operating module, a fingerprint sensing module, and a wireless reception module capable of receiving a wireless terminal signal.

Here when the unlocking module 4 includes an keypad operating module, the keypad operating module can be formed by a touch screen arranged in a head device 7 of the bicycle; when the unlocking module 4 includes a fingerprint sensing module, since the fingerprint sensing module can only be operated on by the rider himself or herself, the locking state of the lock 5 can be prevented from being released by another person; and when the unlocking module 4 includes a wireless reception module, the rider can generate the unlocking instruction using a handset, or another portable terminal, and then the wireless reception module can transmit the unlocking instruction to the control module 2, thus controlling the lock 5 conveniently and rapidly.

Of course, the unlocking module 4 can include all the modules above to thereby providing more options to operate on the unlocking module so as to improve the experience of the user.

Particularly as illustrated in FIG. 2, the control module 2 can particularly include a central control panel 21 and a central control circuit board 31 connected with each other, and the parking switch button 13 can be installed on the central control panel 21 of the control module 2, so that the parking switch button 13 can generate the trigger signal upon being pressed down

Particularly the control module 2 further includes a battery 41, and a lower housing 51 cooperating with the central control panel 21 to define an accommodation cavity in which the battery 41, the central control circuit board 31, etc., are installed, and where the central panel 21 and the lower housing 51 can protect the battery 41, the central control circuit board 31, etc.

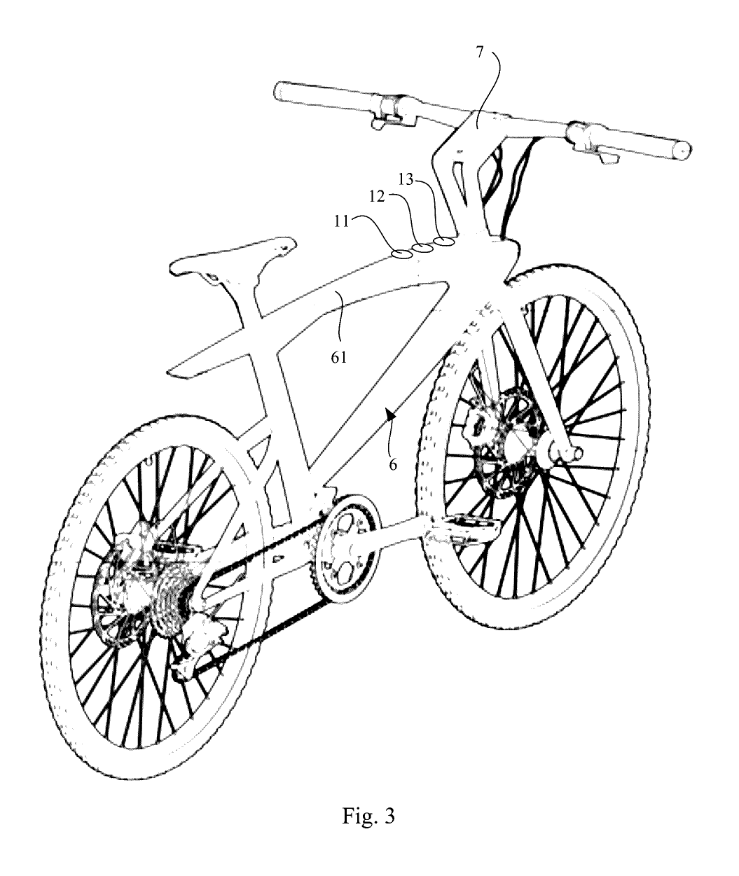

Moreover as illustrated in FIG. 2 and FIG. 3, a bicycle according to some embodiments of the disclosure includes a body 6, and the parking control device according to any one of the embodiments above.

Particularly as illustrated in FIG. 2 and FIG. 3, the body 6 in the bicycle can include a structurally hollow beam 61 in which an embedding groove 62 is arranged, the control module 2 in the parking control device is embedded in the embedding groove 62 of the beam 61 with the parking switch button 13 exposed on the beam 61

Of course, the bicycle above can further include switch buttons for other functions, e.g., a camera switch button 11 corresponding to a camera of the bicycle, and a head lamp switch button 12 corresponding to a head lamp of the bicycle, and particularly the head lamp of the bicycle can be controlled by the head lamp switch button 12, the control module 2, etc., all of which interoperate with each other, and the camera of the bicycle can be controlled by the camera switch button 11, the control module 2, etc., all of which interoperate with each other, although a repeated description thereof has been omitted here.

Lastly it shall be noted that the respective embodiments above are merely intended to illustrate but not to limit the technical solution of the disclosure; and although the disclosure has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the disclosure as claimed.

What is claimed is:

1. A parking control device for a bicycle, comprising a lock, a parking switch button, a posture detection module, an unlocking module, and a control module, wherein:
the parking switch button is installed on a control module, and configured to generate a trigger signal upon being pressed down;
the control module is connected by signals with the parking switch button, the posture detection module, the unlocking module, and the lock; and
when the bicycle is not locked, and the parking switch button is pressed down to generate the trigger signal, the control module determines from posture information of the bicycle detected by the posture detection module whether the bicycle satisfies a parking condition, and if so, then the control module will control the lock to lock the bicycle; and
when the bicycle is locked, the parking switch button is pressed down to generate the trigger signal, and the unlocking module generates a correct unlocking instruction, the control module controls the lock to unlock the bicycle.

2. The parking control device according to claim 1, wherein the lock is an electronic lock.

3. The parking control device according to claim 2, wherein the lock comprises:
a slider configured to protrude into a hole of a brake piece on the bicycle while the bicycle is being parking; and
a drive electro motor connected with the control module and configured to operationally drive the slider into operation.

4. The parking control device according to claim 1, wherein the posture detection module comprises a Hall sensor and/or a gyroscope.

5. The parking control device according to claim 1, wherein the unlocking module comprises a keypad operating module and/or a fingerprint sensing module and/or a wireless reception module capable of receiving a wireless terminal signal.

6. The parking control device according to claim 5, wherein when the unlocking module comprises the keypad operating module and/or the fingerprint sensing module, the unlocking module is formed by a touch screen in a head device of the bicycle.

7. The parking control device according to claim 1, wherein the control module comprises a central control panel and a central control circuit board connected with each other, and the parking switch button is installed on the central control panel.

8. A bicycle, comprising a body, and a parking control device, wherein the parking control device comprises: a lock, a parking switch button, a posture detection module, an unlocking module, and a control module, wherein:
the parking switch button is installed on a control module, and configured to generate a trigger signal upon being pressed down;
the control module is connected by signals with the parking switch button, the posture detection module, the unlocking module, and the lock; and
when the bicycle is not locked, and the parking switch button is pressed down to generate the trigger signal, the control module determines from posture information of the bicycle detected by the posture detection module whether the bicycle satisfies a parking condition, and if so, then the control module will control the lock to lock the bicycle; and
when the bicycle is locked, the parking switch button is pressed down to generate the trigger signal, and the unlocking module generates a correct unlocking instruction, the control module controls the lock to unlock the bicycle.

9. The bicycle according to claim 8, wherein the lock is an electronic lock.

10. The bicycle according to claim 9, wherein the lock comprises:
a slider configured to protrude into a hole of a brake piece on the bicycle while the bicycle is being parking; and
a drive electro motor connected with the control module and configured to operationally drive the slider into operation.

11. The bicycle according to claim 8, wherein the posture detection module comprises a Hall sensor and/or a gyroscope.

12. The bicycle according to claim 8, wherein the unlocking module comprises a keypad operating module and/or a fingerprint sensing module and/or a wireless reception module capable of receiving a wireless terminal signal.

13. The bicycle according to claim 12, wherein when the unlocking module comprises the keypad operating module and/or the fingerprint sensing module, the unlocking module is formed by a touch screen in a head device of the bicycle.

14. The bicycle according to claim 8, wherein the control module comprises a central control panel and a central control circuit board connected with each other, and the parking switch button is installed on the central control panel.

15. The bicycle according to claim 8, wherein the body comprises a structurally hollow beam in which the control module in the parking control device is embedded with the parking switch button exposed on the beam.

16. The bicycle according to claim 8, further comprising a head device comprising a touch screen, and when the unlocking module in the parking control device comprises a keypad operating module and/or a finger sensing module, the unlocking module is formed by the touch screen of the head device of the bicycle.
